(19) United States
(12) Patent Application Publication
(10) Pub. No.: US 2011/0153111 A1
(43) Pub. Date: Jun. 23, 2011

(54) STANDBY POWER CONTROL DEVICE AND CONTROL METHOD THEREOF

(75) Inventors: Yoonmee Doh, Daejeon (KR); Noseong Park, Daejeon (KR); Jong-Arm Jun, Daejeon (KR); Cheol Sig Pyo, Daejeon (KR)

(73) Assignee: Electronics and Telecommunications Research Institute, Daejeon (KR)

(21) Appl. No.: 12/833,459

(22) Filed: Jul. 9, 2010

(30) Foreign Application Priority Data
Dec. 18, 2009 (KR) 10-2009-0127218

(51) Int. Cl. G06F 19/00

(52) U.S. Cl. 700/296

(57) ABSTRACT

Provided is a power control device and a control method thereof for reducing power consumption. A standby power control devices includes a plurality of electronic devices each of which is operated in a standby mode and a normal mode, and a central control unit configured to monitor load power consumed by one of the electronic devices, and perform a control operation for electrically connecting or isolating the one of the electronic devices to or from a power line by referring to a result of the monitoring and each profile information of the electronic devices, wherein the central control unit controls the one of the electronic devices to be isolated or keep a connection from or to the power line when the load power consumed by the one of the electronic devices is kept as the standby mode over a reference time.

### CROSS-REFERENCE TO RELATED APPLICATIONS

This U.S. non-provisional patent application claims priority under 35 U.S.C. §119 of Korean Patent Application No. 10-2009-0127218, filed on Dec. 18, 2009, the entire contents of which are hereby incorporated by reference.

### BACKGROUND OF THE INVENTION

The present invention disclosed herein relates to a power control device, and more particularly, to a power control device and a control method thereof for reducing power consumption by turning off standby power to electronic devices.

Recently, the efforts to reduce carbon dioxide emissions have attracted attentions globally because the issues of energy source exhaustion and global warming were raised. The reduction of carbon dioxide emissions relate to technology for reducing energy consumption. One of the most practical and simple methods of reducing energy consumption is, e.g., turning off lights of an empty conference room or shutting off power to electronic devices which are unused. That is, the method is minimizing consumption of usable power.

The kinds of home appliances such as televisions, audios, microwaves, electric rice cookers and computers are rapidly increasing. However, most of users tend not to unplug the electronic devices even when they are unused. While the electronic devices are plugged in at a power off state, they consume considerably large power, i.e., standby power. The International Energy Agency has reported that about 5% to 15% of household electric power is wasted worldwide due to standby power. It has reported that this wasted standby power corresponds to about 1% of worldwide carbon dioxide emissions.

Therefore, for solving this matter of standby power, various activities of public relations are being conducted and various devices are being suggested. These efforts have been made to reduce power waste at a standby mode state within limitations of not decreasing convenience of users. However, the best way to fundamentally reduce the standby power consumption is to unplug the unused electronic devices. However, the method of manually unplugging electronic devices is merely a passive method depending on participation of users. Further, in the case of unplugging a power cord, the use of a remote controller for convenience of users is limited.

Accordingly, new effective devices and methods are desired for automatically controlling supply of standby power, not depending on active handling of users and guaranteeing maximum convenience of users.

### SUMMARY OF THE INVENTION

Embodiments of the present invention provide a standby power control device and a control method thereof for automatically controlling standby power with providing convenience to a user when an electronic device is used.

In some embodiments of the present invention, standby power control devices include: a plurality of electronic devices each of which is operated in a standby mode and a normal mode; and a central control unit configured to monitor load power consumed by one of the electronic devices, and perform a control operation for electrically connecting or isolating the one of the electronic devices to or from a power line by referring to a result of the monitoring and each profile information of the electronic devices, wherein the central control unit controls the one of the electronic devices to be isolated or keep a connection from or to the power line when the load power consumed by the one of the electronic devices is kept as the standby mode over a reference time.

In other embodiments of the present invention, methods for controlling standby power of a plurality of electronic devices include: detecting power consumed by each of the electronic devices; determining whether there is one whose power consumption is kept as a standby mode over a reference time among the electronic devices; and electrically isolating the electronic device which is kept as the standby mode over the reference time from a power line by referring to profile information, wherein the profile information includes identifier information of an electronic device among the electronic devices whose connection to the power line is maintained even if it is kept as the standby mode over the reference time.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a standby power management system according to an embodiment of the present invention;

FIG. 2 is a block diagram illustrating an embodiment of the central control unit and the local control unit of FIG. 1;

FIGS. 3A and 3B are flowcharts illustrating a method for shutting off power consumed at the standby mode according to the embodiment of the present invention;

FIGS. 4A and 4B are flowcharts illustrating a method of restoring to the standby mode according to the embodiment of the present invention;

FIG. 5 is a table illustrating the profile of the electronic device according to the embodiment of the present invention;

FIG. 6 is a block diagram illustrating another embodiment of the central control unit and the local control unit; and

FIGS. 7A and 7B are waveform diagrams of consumed power illustrating effects of the embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, it will be described about an exemplary embodiment of the present invention in conjunction with the accompanying drawings.

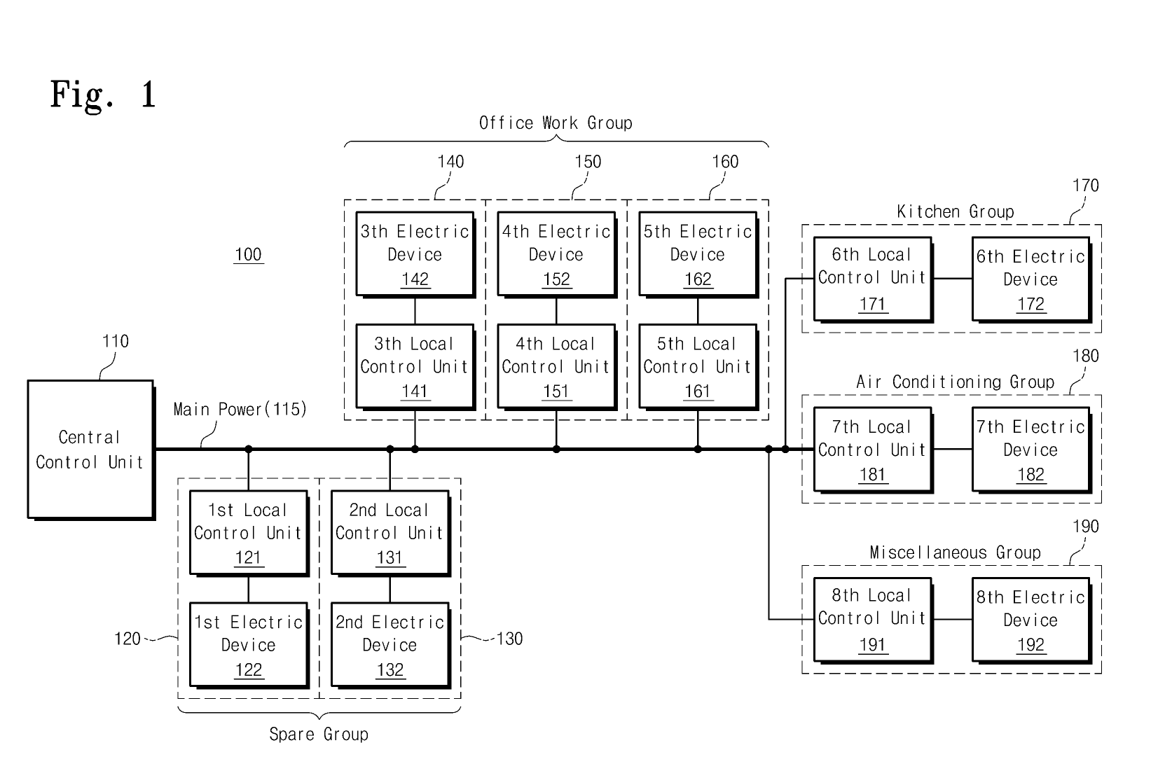

FIG. 1 is a block diagram illustrating a standby power management system according to an embodiment of the present invention.

Referring to FIG. 1, the standby power management system 100 includes a central control unit 110 and a plurality of consumption units 120 to 190. The consumption units 120 to 190 may be classified into a plurality of device groups according to uses or purposes. The device groups include a spare group (120, 130), an office work group (140 to 160), a kitchen group (170), an air conditioning group (180) and a miscellaneous group (190).

The central control unit 110 may control a main power source 115 and first to eighth electronic devices 122, 132, 142, 152, 162, 172, 182 and 192 with the device group or the consumption unit as a unit. The central control unit 110 includes a profile which corresponds to specifications of each electronic device or setup information of the device groups. Accordingly, when the central control unit 110 detects power change which corresponds to one of the device groups or one of the electronic devices, the central control unit 110 may order to shut off power to the corresponding electronic device.

For instance, when it is detected that power consumption of the first electronic device 122 changes from a normal mode to a standby mode, the central control unit 110 measures time elapsed from the timing when the first electronic device 122 changes to the standby mode. The detection information about the conversion to the standby mode or the normal mode is periodically provided to the central control unit 110 from a first local control unit 121. When it is determined that the first electronic device 122 is still in the standby mode even in the case where the elapsed time is over a reference time, the central control unit 110 orders the first local control unit 121 to electrically shut off the first electronic device 122 and the main power source 115.

On the contrary, at the state where the first electronic device 122 and the main power source 115 are electrically separated from each other, input/output of a user is referenced in order to restore the first electronic device 122 to the standby mode. For instance, the central control unit 110 may detect that the user reaches a position for using the first electronic device 122 through a sensor, and then order the first local control unit 121 to restore to the standby mode. Or, the central control unit 110 may also order the first local control unit 121 to restore to the standby mode in the case where the user selects to use the first electronic device 122 through an input/output device of the central control unit 110.

The consumption units 120 to 190 include the first to the eighth electronic devices 122 to 192 supplied with power from the main power source 115. Each of the first to the eighth electronic devices 122 to 192 is electrically connected to or isolated from the main power source 115 by corresponding local control units, i.e., 121 to 191.

Functions of the consumption unit 120 to 190 will now be explained by describing one consumption unit, i.e., 120. The consumption unit 120 includes the first electronic device 122 and the first local control unit 121 which controls connection or isolation between the first electronic device 122 and the main power source 115. The first local control unit 121 monitors a power state of the first electronic device 122. When the power state of the first electronic device 122 is changed from the normal mode to the standby mode, the first local control unit 121 periodically transfers this power state to the central control unit 110. The first local control unit 121 transfers the power state information to the central control unit 110 including a unique device identifier allotted to the first electronic device 122.

Also, the first local control unit 121 electrically connects or isolates the first electronic device 122 to or from the main power source 115 according to a power shutoff command or a power supply command provided from the central control unit 110. Although a control relation between the central control unit 110 and the consumption unit 120 has been described as above, this control scheme is applied to all of the consumption units 120 to 190. The power control of the electronic devices by the central control unit 110 may be performed with a consumption unit or a device group as a unit.

In addition, although it has been described that the first to the eighth local control units 121 to 191 isolate corresponding electronic devices from the main power source 115 according to the order of the central control unit 110, the present invention is not limited by this embodiment. That is, the local control units may measure the elapsed time after the conversion to the standby mode, and switch the main power source 115 for themselves referring to a result of the measurement. According to the operation of isolating the main power source 115 from corresponding electronic devices performed by the first to the eighth local control units 121 to 191, an effect of substantially unplugging a power cord can be obtained.

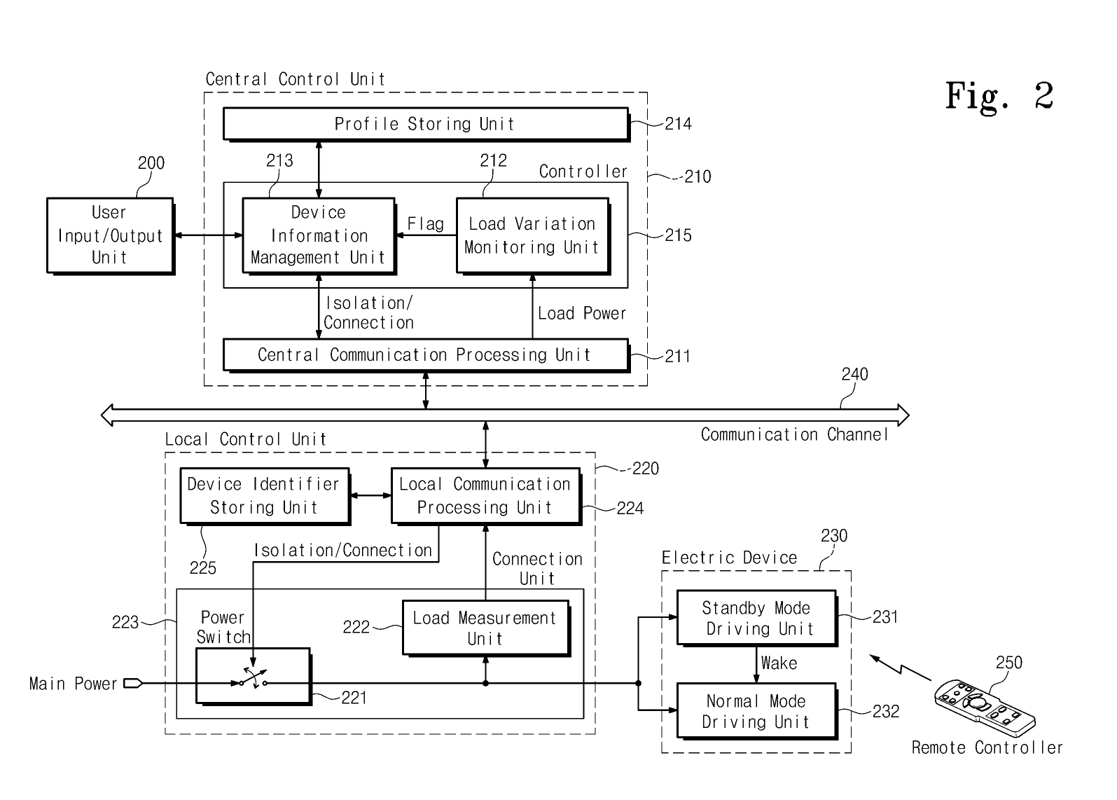

FIG. 2 is a block diagram illustrating an embodiment of the central control unit and the consumption unit.

Referring to FIG. 2, a structure of one consumption unit (220, 230) and central control unit 210 is illustrated. However, this structure and function may be equally applied to the other consumption units described in FIG. 1.

A user input/output unit 200 is a structure for operating the standby power control device or changing its configuration by the user. That is, the user accesses the central control unit 210 through the user input/output unit 200 in order to change the profile stored in the central control unit 210. Also, the user input/output unit 200 senses a movement of the user, and provides it to the central control unit 210. When the user input/output unit 200 detects that the user reaches a position for using the electronic device 230 through a sensor, the user input/output unit 200 reports this state to the central control unit 210. Then, in the case where the main power is currently shut off, the central control unit 210 may order the local control unit 220 to restore to the standby mode. Or, in the case where the user selects to use the electronic device 230 using the user input/output unit 200 of the central control unit 210, the central control unit 210 may also order the local control unit 220 to restore to the standby mode.

The central control unit 210 includes a central communication processing unit 211, a load variation monitoring unit 212, a device information management unit 213 and a profile storing unit 214. The load variation monitoring unit 212 and the device information management unit 213 are included in a controller 215.

The central communication processing unit 211 performs an interfacing operation with the local control unit 220. The central communication processing unit 211 decodes data provided from the local control unit 220. The central communication processing unit 211 classifies the data provided from the local control unit 220 into level information of load power of the electronic device 230 and device identifier information. The central communication processing unit 211 provides the level information of load power to the load variation monitoring unit 212. The central communication processing unit 211 provides the device identifier information to the device information management unit 213.

The load variation monitoring unit 212 refers to the periodically provided load power level of the electronic device 230, and determines whether there is a transition to the standby mode or the normal mode. The load variation monitoring unit 212 keeps its current monitoring state in the case where a previously received load power level of the electronic device 230 is equal to a currently received load power level. However, in the case where the previously received load power level of the electronic device 230 is different from the currently received load power level, the load variation monitoring unit 212 counts elapsed time from the time when the level is changed.

Suppose that the previously received load power level corresponds to the normal mode, but the currently received load power level corresponds to the standby mode. At this time, the load variation monitoring unit 212 monitors whether the standby mode is kept until a reference time Δt is passed from a level transition occurrence time t₁. When the load power is converted to the normal mode again before the reference time Δt is passed, the load variation monitoring unit 212 stops counting. However, when the load power still keeps the standby mode even after the reference time Δt is passed, the load variation monitoring unit 212 transfers a flag signal to the device information management unit 213.

The device information management unit 213 obtains a profile of a corresponding electronic device from the profile storing unit 214 in response to the flag signal. The profile may include current state and device group information of the electronic device 230, and information to be checked before giving order. In the case where the profile is configured for the electronic device 230 to be kept in a turned-on state always, the device information management unit 213 does not give a shutoff order even if the flag signal is delivered. However, in the case where the configuration is not for always turning-on power, the device information management unit 213 gives an order for shutting off main power to the local control unit 220 through the central communication processing unit 220.

The local control unit 220 includes a power switch 221, a load measurement unit 222, a local communication processing unit 224 and a device identifier storing unit 225. The power switch 221 and the load measurement unit 222 are included in a connection unit 223.

The power switch 221 electrically isolates or connects the main power from or to the electronic device 230. The power switch 221 switches the main power in response to an isolation/connection control signal, wherein the local communication processing unit 224 decodes a command substantially transferred from the central control unit 210 and provides the decoded command as the isolation/connection control signal. When the electronic device 230 is powered off by the power switch 221, power consumption of the electronic device 230 substantially becomes about 0. This has the same effect as unplugging a power cord.

The load measurement unit 222 senses the main power provided to the electronic device 230 by the power switch 221. The load measurement unit 222 detects whether driving power of the electronic device 230 is in the normal mode or the standby mode. The load measurement unit 222 periodically transmits the detected driving mode of load power or information about load power to the central control unit 210 through the local communication processing unit 224. A period of transmitting the information about load power by the load measurement unit 222 is provided as an optimum value by the user.

The local communication processing unit 224 combines the load power information provided from the load measurement unit 222 with the device identifier stored in the device identifier storing unit 225, and transfers it to the central control unit 210. Also, the local communication processing unit 224 receives an isolation/connection command for the power switch 221 from the central control unit 210. The local communication processing unit 224 checks whether the device identifier included in the isolation/connection command received from the central control unit 210 corresponds to the electronic device 230. To this end, the local communication processing unit 224 compares the device identifier provided from the device identifier storing unit 225 with that received from the central control unit 210. In the case where the device identifier provided from the device identifier storing unit 225 is in accord with the device identifier received from the central control unit 210, the local communication processing unit 224 follows procedures for performing the isolation/connection command. In the case where the device identifier provided from the device identifier storing unit 225 is in accord with the device identifier received from the central control unit 210, the local communication processing unit 224 converts the received isolation/connection command into the isolation/connection control signal, and transfers it to the power switch 221.

The device identifier storing unit 225 stores unique identifying information, i.e., the device identifier, allotted to the electronic device 230 among plural electronic devices. The device identifier storing unit 225 provides the device identifier allotted to the electronic device 230 to the local communication processing unit 224. In the case where the information about load power is transmitted by the local communication processing unit 224, the device identifier stored in the device identifier storing unit 225 may be transferred together with the information about load power.

The electronic device 230 provides various services to the user using the main power, which is provided via the power switch 221, as an energy source. The electronic device 230 includes a standby mode driving circuit 231 and a normal mode driving circuit 232. The standby mode driving circuit 231 supplies standby power consumed by the electronic device 230 when the user selects a power off state of the power switch of the electronic device 230 or keeps the standby mode. The normal mode driving circuit 232 supplies power to the electronic device 230 at a normal driving state. In the case where the user turns on the power switch, or converts to the normal mode using a remote controller 250, the standby mode driving circuit 231 enables the normal mode driving circuit 232.

Various channels which enable communications between the central control unit 210 and the local control unit 220 are commonly called a communication channel 240. For instance, the communication channel 240 may be structured with a wireless local area network. Or, the communication channel 240 may be structured by wire. Or, the central control unit 210 may communicate with the local control unit 220 with the method of Power Line Communication (PLC). In this case, the communication channel 240 may be structured with a power line where the main power is transferred without an additional structure.

The standby power control device, in which the central control unit 210 commands the isolation/connection of the main power referring to the load power information of the electronic device 230 detected by the local control unit 220, has been described as above. According to the standby power control device of the present invention, the electronic device, which is kept in the standby mode for the reference time, is automatically powered off. In the case where the user reaches a particular position, the electronic device 230 may be automatically converted to the standby mode. Therefore, according to the embodiment of the present invention, consumption of the standby power can be efficiently prevented without inconvenience of the user.

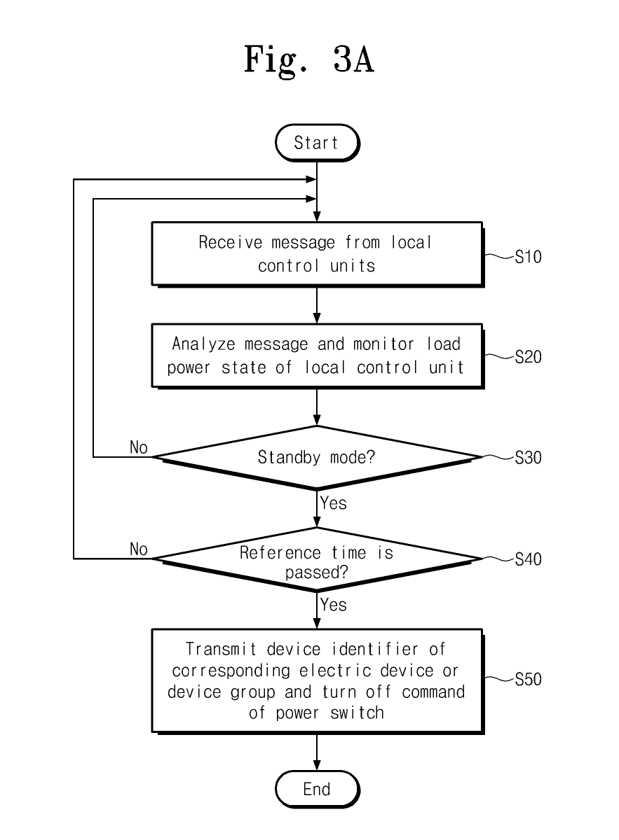

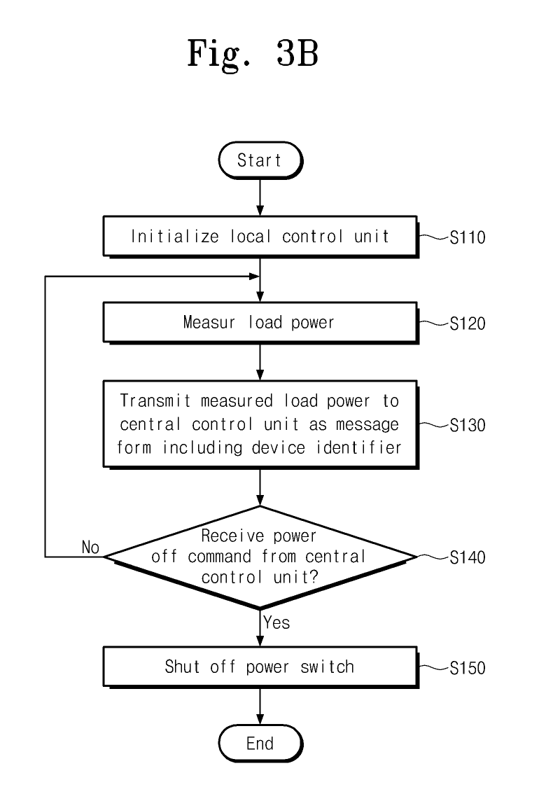

FIGS. 3A and 3B are flowcharts illustrating control procedures for converting a power mode of the electronic device from the normal mode to the standby mode. FIG. 3A is a flowchart illustrating an operating procedure of the central control unit 210, and FIG. 3B is a flowchart illustrating an operating procedure of the local control unit 220.

Referring to FIG. 3A, firstly at a step S10, the central control unit 210 receives a message, which is periodically generated, from the local control unit 220. In this message, the load power information and the device identifier information which correspond to the local control unit 220 are included. Such a message is periodically received from not only the local control unit 220 but also local control units which respectively correspond to plural electronic devices.

At a step S20, the central control unit 210 analyzes the received message, and determines whether there is variation of the load power sensed by the local control unit 220. That is, it monitors whether there is a power mode transition from the normal mode to the standby mode.

At a step S30, when it is determined that the normal mode state is maintained by the load variation monitoring unit 212 of the central control unit 210, the procedure is returned to the step S10. On the contrary, when it is determined that there is variation of the load power, the procedure is moved to a step S40. That is, when it is detected that the load power is changed from the normal mode to the standby mode, the central control unit 210 follows procedures for controlling standby power.

At the step S40, the load variation monitoring unit 212 continuously monitors the message about the load power, and counts the time elapsed from the transition time when the power mode is changed from the normal mode to the standby mode. If the power mode is restored to the normal mode before the reference time Δt is passed, the procedure is returned to the step S10, and the load variation monitoring unit 212 continuously receives the message and monitors the state of load power. However, in the case where the load power keeps the standby mode until the reference time Δt is passed, the procedure is moved to a step S50.

At the step S50, the device information management unit 213 receives the device identifier from the profile storing unit 214, and transmits the isolation command of the power switch via the central communication processing unit 211.

The operating procedure of determining whether there is variation of the load power of the electronic device 230 by the central control unit 210, and measuring the elapsed time, and performing the isolation operation has been described as above. In response to the action of the central control unit 210 described in FIG. 3A, FIG. 3B illustrates the operating procedure of the local control unit 220.

At a step S110, the local control unit 220 initializes all sorts of functions. At a step S120, the measurement of load power by the load measurement unit 222 of the local control unit 220 is started

At a step S130, the information of load power measured by the load measurement unit 222 is periodically transferred to the central control unit 210 through the local communication processing unit 224. Particularly, the local communication processing unit 224 combines the load power with the device identifier information stored in the device identifier storing unit 225, and transmits it to the central control unit 210.

At a step S140, in response to the transmitted message, it is determined whether the power isolation command is received from the central control unit 210. If the power isolation command is not received, the procedure is returned to the step S120 for continuously monitoring the variation of load power. On the contrary, if it is determined that the power isolation command is received from the central control unit 210, the procedure is moved to a step S150.

At the step S150, the local communication processing unit 224 provides the isolation control signal to the power switch 221. Then, the main power is electrically isolated from the electronic device 230. According to this procedure, the power mode of the electronic device 230 is changed to the standby mode, and the main power may be isolated if the reference time is passed. Accordingly, there occurs the same effect as unplugging a power cord.

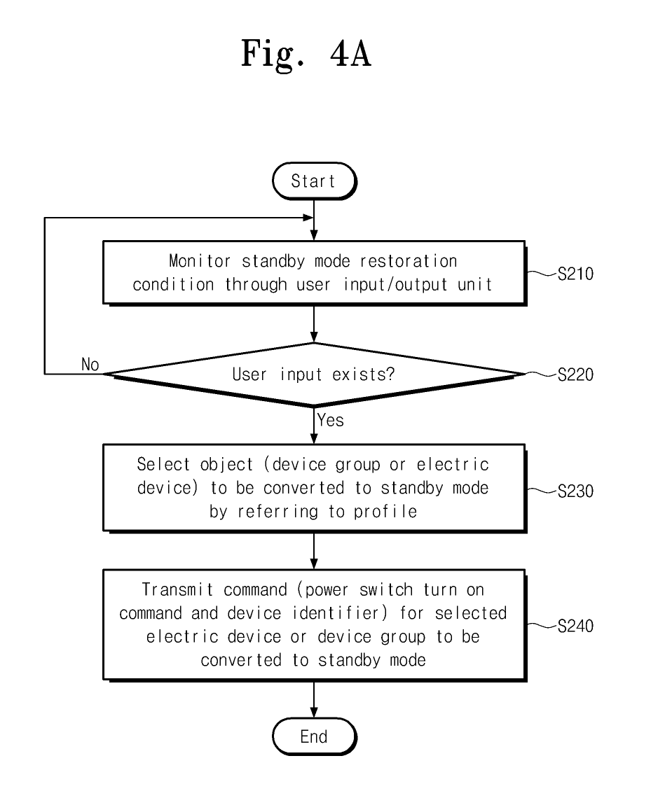

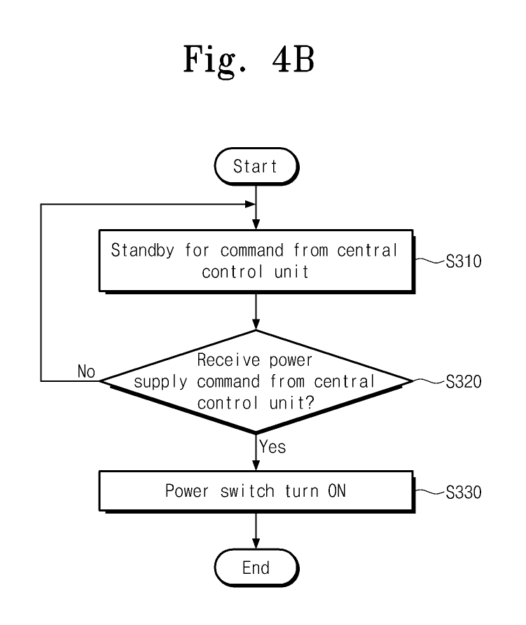

FIGS. 4A and 4B are flowcharts respectively illustrating operating procedures of the central control unit 210 and the local control unit 220 for restoring the power mode to the standby mode from the state where the main power to the electronic device 230 is off. FIG. 4A illustrates the operation of the central control unit 210, and FIG. 4B illustrates the operation of the local control unit 220.

Referring to FIG. 4A, the control procedure of the central control unit 210 is started from the monitoring operation at a step S210.

At the step S210, the central control unit 210 monitors whether there occurs an event of standby mode restoration by the user through the user input/output unit 200. That is, it is monitored whether a condition of standby mode restoration, in which supply of the main power by the central control unit 210 is selected by the user or the user enters a region of a particular device group, is generated.

At a step S220, if there is not an input of the user, the procedure is moved to the step S210 for continuously monitoring the condition of standby mode restoration. On the contrary, if there is the input of the user, the procedure is moved to a step S230 for the standby mode restoration.

At the step S230, the device information management unit 213 reads a state of the device group or electronic device selected by the user from the profile storing unit 214. And, by referring to the profile of the device group or electronic device, a device group or electronic device to be restored to the standby mode is selected.

At a step S240, the device information management unit 213 transmits a command for restoring the power mode of the electronic device selected by the user to the standby mode. The command includes information for ordering turn-on of the power switch and the device identifier information of a corresponding electronic device.

In response to the above-mentioned command of the central control unit 210, a procedure of standby mode restoration performed by the local control unit 220 is illustrated in FIG. 4B.

At a step S310, the local control unit 220 detects whether there is a command provided from the central control unit 210. At a step S320, in the case where the local control unit 220 cannot receive the power supply command from the central control unit 210, the procedure is fedback to the step S310. However, in the case where the local control unit 220 receives the power supply command from the central control unit 210, the procedure is moved to a step S330.

At the step S330, the local communication processing unit 224 of the local control unit 220 outputs the connection control signal for turning on the power switch 221 according to the power supply command. Then, the main power is electrically connected to the electronic device 230 through the power switch 221. And, the standby mode driving circuit 231 of the electronic device 230 is enabled.

The procedures of shutting off standby power and restoring to the standby mode have been described through the above-mentioned flowcharts FIGS. 3A, 3B, 4A and 4B. By shutting off the standby power, the effect of unplugging a power cord is provided. By restoring to the standby mode, the effect of plugging a power code is provided. Accordingly, without inconvenience of the user, it is possible to efficiently shut off standby power.

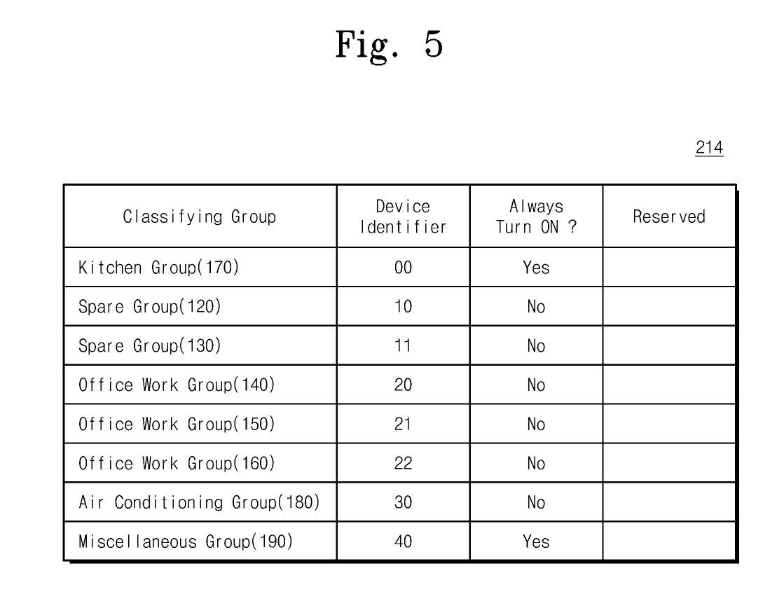

FIG. 5 is a table briefly illustrating an example of the profile stored in the profile storing unit 214 of FIG. 2.

Referring to FIG. 5, the consumption units may be classified into the kitchen group (170, refer to FIG. 1), the spare group (120, 130), the office work group (140 to 160), the air conditioning group (180) and the miscellaneous group (190).

A device identifier ‘00’ is allotted to the sixth electronic device 172 which corresponds to the kitchen group 170. When the central control unit 110 provides a command corresponding to the kitchen group, it encodes the command so that the device identifier ‘00’ is included. And, when the sixth local control unit 171 which corresponds to the kitchen group 170 transmits the load power level to the central control unit 110, the device identifier ‘00’ is included in the transmission. Accordingly, the central control unit 110 and the local control unit 171 may designate or identify the object through the device identifier ‘00’.

Among electronic devices, there is such a device as refrigerator which should be constantly supplied with power. The power mode of such an electronic device should not be converted into the standby mode or shut off state. Accordingly, a configuration for such an electronic device or device group is needed. Referring to the table, the electronic devices included in the kitchen group (170) and the miscellaneous group (190) may be configured to ‘Yes’ at the item of ‘Always turn-on?’. It is configured for the electronic devices included in the kitchen group (170) and the miscellaneous group (190) not to be converted into the standby mode nor powered off. That is, the profile may be such configured so as for the electronic devices included in the kitchen group (170) and the miscellaneous group (190) to be always supplied with power of the normal mode.

On the contrary, the electronic devices which correspond to the spare group (120, 130), the office work group (140 to 160) and the air conditioning group (180) may be configured to ‘No’ at the item of ‘Always turn-on?’. Therefore, the electronic devices which correspond to the spare group (120, 130), the office work group (140 to 160) and the air conditioning group (180) are controlled according to the standby power control method of the present invention.

In this manner, the profile of the electronic devices which correspond to the spare group (120, 130), the office work group (140 to 160), the kitchen group (170), the air conditioning group (180) and the miscellaneous group (190) may be stored into the central control unit 110. And, the user may reconfigure or update the profile as needed. The device identifier allotted to the above-mentioned profile is also stored into the local control units of the consumption units.

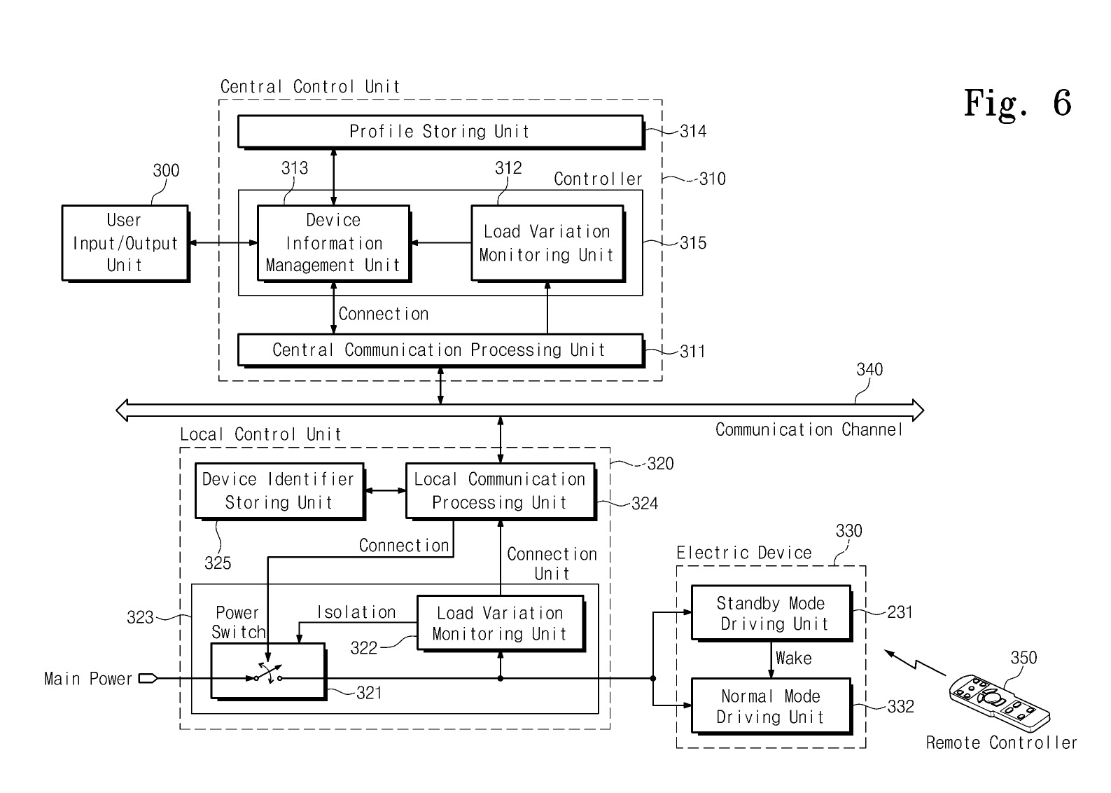

FIG. 6 is a block diagram illustrating another embodiment of a central control unit 310 and a local control unit 320 of the present invention. FIG. 6 illustrates an example where the determining operation for shutting off a power switch 321 is performed within the local control unit 320.

A user input/output unit 300 is configured for the user to operate the standby power control device or change its configuration. That is, the user accesses the central control unit 310 through the user input/output unit 300 in order to change the profile stored in the central control unit 310. Also, the user input/output unit 300 senses a movement of the user, and provides it to the central control unit 310. When the user input/output unit 300 detects that the user arrives at a position for using an electronic device 330 through a sensor, it reports this state to the central control unit 310. Then, in the case where the main power is currently shut off, the central control unit 310 may order the local control unit 320 to restore to the standby mode. Or, in the case where the user selects to use the electronic device 330 using the user input/output unit 300 of the central control unit 310, the central control unit 310 may also order the local control unit 320 to restore to the standby mode.

The central control unit 310 includes a central communication processing unit 311, a load variation management unit 312, a device information management unit 313 and a profile storing unit 314. The load variation management unit 312 and the device information management unit 313 are included in a controller 315.

The central communication processing unit 311 performs an interfacing operation with the local control unit 320. The central communication processing unit 311 decodes data provided from the local control unit 320. The central communication processing unit 311 classifies the data provided from the local control unit 320 into information of load power of the electronic device 330 and device identifier information. The central communication processing unit 311 provides the information of load power to the load variation management unit 312. The central communication processing unit 311 provides the device identifier information to the device information management unit 313.

The load variation management unit 312 refers to the periodically provided load power level of the electronic device 330, and determines whether there is a transition to the standby mode or the normal mode. And, the load variation management unit 312 may display this load power state at the user input/output unit 300. However, unlike the load variation monitoring unit 212 of FIG. 2, the load variation management unit 312 does not include a control function for shutting off the load power.

The device information management unit 313 transfers the load power information provided from the load variation management unit 312 to the user input/output unit 300. Particularly, the device information management unit 313 obtains the profile of a corresponding device from the profile storing unit 314, and may inform the user of the load power state of a particular device group or electronic device.

Also, the device information management unit 313 may refer to a standby mode restoration event provided from the user input/output unit 300, and provide a command to the local control unit 320 for connecting the main power. At this time, the device information management unit 313 obtains the profile of a corresponding device from the profile storing unit 314. By referring to the profile, the device information management unit 313 gives an order to the local control unit 320 to convert to the standby mode including the device identifier of the corresponding electronic device 330.

The local control unit 320 includes the power switch 321, a load variation monitoring unit 322, a local communication processing unit 324 and a device identifier storing unit 325. The power switch 321 and the load variation monitoring unit 322 are included in the connection unit 323.

The power switch 321 electrically isolates or connects the main power from or to the electronic device 330. The power switch 321 is turned on in response to a connection control signal, wherein the local communication processing unit 324 decodes a command substantially transferred from the central control unit 310 and provides the decoded command as the connection control signal. The power switch 321 is turned off in response to an isolation control signal provided by the load variation monitoring unit 322.

The load variation monitoring unit 322 senses the main power provided to the electronic device 330. The load variation monitoring unit 322 detects whether the driving power of the electronic device 330 is in the normal mode or normal mode, and periodically transmits the detected result to the central control unit 310 through the local communication processing unit 324. A period of transmitting the information about load power by the load variation monitoring unit is provided as an optimum value by the user.

In addition, the load variation monitoring unit 322 performs the isolation operation to the power switch 321 for itself. Suppose that previous load power of the electronic device 330 is the normal mode level, but current load power is the standby mode level. At this time, the load variation monitoring unit 322 monitors whether the standby mode is kept until a reference time Δt is passed from a level transition occurrence time. When the received load power information tells that the load power is converted to the normal mode again before the reference time Δt is passed, the load variation monitoring unit 322 stops counting. However, when the load power still keeps the standby mode even after the reference time Δt is passed, the load variation monitoring unit 322 provides the isolation control signal to the power switch 321.

The local communication processing unit 324 adds the load power information provided from the load variation monitoring unit 322 and the identifier stored in the device identifier storing unit 325 together, and transmits it to the central control unit 310. The local communication processing unit 324 also receives a connection command for the power switch 321 provided from the central control unit 310. The local communication processing unit 324 converts the received connection command to the connection control signal for substantially control the power switch, and transfers the connection control signal to the power switch 321.

The device identifier storing unit 325 stores unique identifier information allotted to the electronic device 330 among plural electronic devices. When particular information is transmitted by the local communication processing unit 324, the identifier information stored in the device identifier storing unit 325 may be transferred together with it.

The electronic device 330 provides various services to the user using the main power, which is provided via the power switch 321, as an energy source. The electronic device 330 includes a standby mode driving circuit 331 and a normal mode driving circuit 332. The standby mode driving circuit 331 supplies standby power consumed by the electronic device 330 when the user selects a power off state of the power switch of the electronic device 330 or keeps the standby mode. The normal mode driving circuit 332 supplies power to the electronic device 330 at a normal driving state. In the case where the user turns on the power switch, or converts to the normal mode using a remote controller 350, the standby mode driving circuit 331 enables the normal mode driving circuit 332.

Various channels which enable communications between the central control unit 310 and the local control unit 320 are commonly called a communication channel 340. For instance, the communication channel 340 may be structured with a wireless local area network. Or, the communication channel 340 may be structured by wire. Or, the central control unit 310 may communicate with the local control unit 320 with the method of PLC. In this case, the communication channel 340 may be structured with a power line where the main power is transferred without an additional structure.

In the embodiment above-described referring to FIG. 6, the load variation monitoring unit 322, which shuts off the main power at the standby mode, is included in the local control unit 320. This is different from the embodiment of FIG. 2. However, the operation of converting to the standby mode by the user is performed in the same manner as the embodiment of FIG. 2.

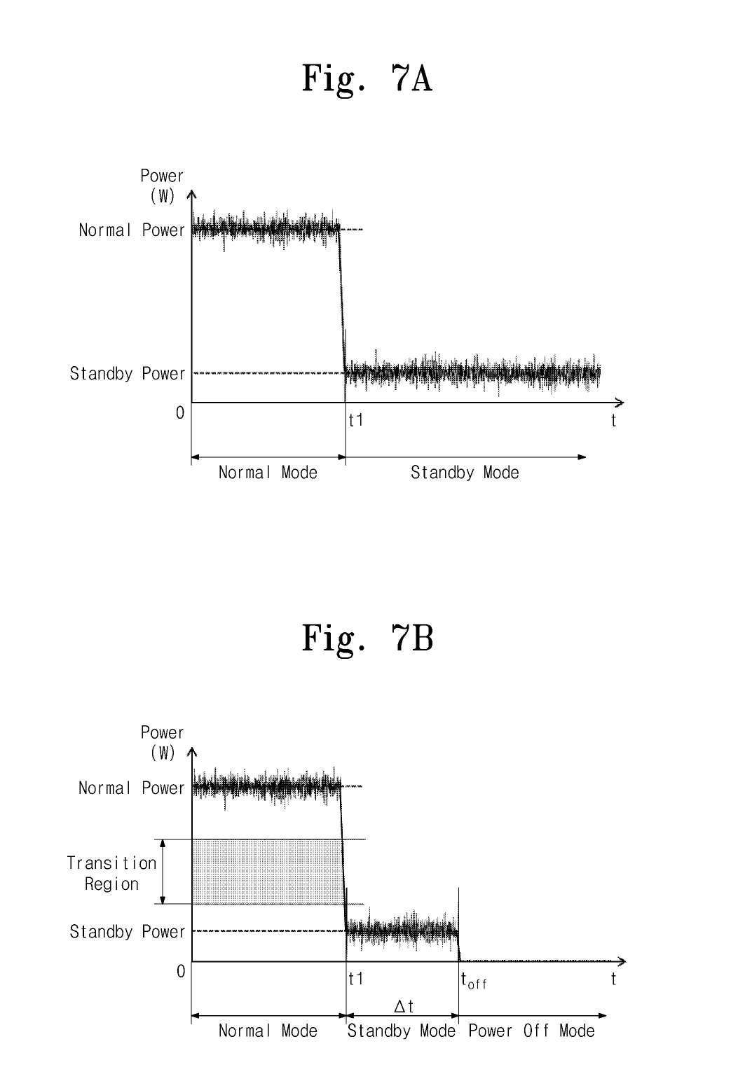

FIG. 7A is a wave diagram illustrating power difference between the normal mode and the standby mode. FIG. 7B is a wave diagram illustrating the method of controlling the standby power by detecting the conversion to the standby mode according to the embodiment of the present invention. Referring to FIG. 7B, in the present invention, the conversion from the normal mode to the standby mode may be detected by detecting a falling edge of power. This power mode conversion may be performed by the load variation monitoring unit 212 included in the central control unit 210 of FIG. 2, or the load variation monitoring unit 322 included in the local control unit 320 of FIG. 6.

Also, the effect of the present invention may be visually explained through the wave diagrams illustrated in FIGS. 7A and 7B. FIG. 7A illustrates a wave of power consumption in the case where the main power is not disconnected from the electronic device. FIG. 7B illustrates a wave of power consumption at the standby mode according to the embodiment of the present invention.

In FIG. 7A, after conversion from the normal mode to the standby mode, the standby power is continuously consumed. However, in the wave diagram of FIG. 7B, the power switch is automatically shut off at the time t_{off} when the reference time Δt is passed from the conversion time t₁, wherein the power mode is converted to the standby mode at the conversion time t₁. Then, the main power is electrically disconnected from the electronic device. That is, FIG. 7B shows that the standby power consumption can be prevented having the same effect of unplugging a power cord.

According to the embodiment of the present invention, an electronic device or device group, which is driven by standby power for a certain time, can be automatically powered off, and automatically restored to the standby mode by a user. Accordingly, the power control device of the present invention can efficiently stop the standby power consumption while providing convenience to the user when the user uses the electronic device.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A standby power control device, comprising:
a plurality of electronic devices each of which is operated in a standby mode and a normal mode; and
a central control unit configured to monitor load power consumed by one of the electronic devices, and perform a control operation for electrically connecting or isolating the one of the electronic devices to or from a power line by referring to a result of the monitoring and each profile information of the electronic devices,
wherein the central control unit controls the one of the electronic devices to be isolated or keep a connection from or to the power line when the load power consumed by the one of the electronic devices is kept as the standby mode over a reference time.

2. The standby power control device of claim 1, wherein the central control unit keeps the connection between the power line and the one of the electronic devices even if the power load is kept as the standby mode over the reference time when the profile information is configured to always provide power to the one of the electronic devices.

3. The standby power control device of claim 2, wherein the profile information includes device identifier information which uniquely defines the one of the electronic devices.

4. The standby power control device of claim 1, wherein the central control unit electrically connects the power line to the one of the electronic devices for conversion from an isolation state to the standby mode by sensing use of the one of the electronic devices by a user or sensing an input which corresponds to a standby mode restoration, wherein the use by the user is sensed using a sensor.

5. The standby power control device of claim 4, further comprising a user input/output unit for sensing the use of the one of the electronic devices by the user and sensing the input which corresponds to the standby mode restoration, or receiving a configuration of the user.

6. The standby power control device of claim 5, wherein the profile information may be changed through the user input/output unit.

7. The standby power control device of claim 1, further comprising a plurality of local control units configured to isolate or connect the power line from or to each of the electronic devices according to control of the central control unit.

8. The standby power control device of claim 7, wherein each of the local control units comprises:
a device identifier storing unit configured to store device identifier information of a corresponding electronic device;
a power switch configured to switch the power line and power of the electronic devices;
a load measurement unit configured to sense load power consumed by the corresponding electronic device, and periodically generate level information of the load power; and
a local communication processing unit configured to combine the periodically generated level information of the load power and the device identifier information, and transmit the combined information to the central control unit.

9. The standby power control device of claim 8, wherein the local communication processing unit controls the power switch by decoding control information provided from the central control unit.

10. The standby power control device of claim 7, wherein the central control unit comprises:
a profile storing unit configured to store the profile information;
a central communication processing unit configured to receive the level information of the load power, and transmit a command for isolating or connecting the one of the electronic devices from or to the power line;
a load variation monitoring unit configured to monitor the level information of the load power, and generate a flag signal when the load power consumed by the one of the electronic devices is kept as the standby mode over the reference time; and
a device information management unit configured to provide a command for electrically isolating the power line from the one of the electronic devices to the central communication processing unit by referring to the flag signal and a device identifier included in the profile information.

11. The standby power control device of claim 10, wherein the profile information further comprises classifying information for classifying the electronic devices into a plurality of device groups according to use or purpose.

12. The standby power control device of claim 11, the central control unit references to the classifying information and controls the standby power of the electronic devices with the device group as a unit.

13. A standby power control device, comprising:
an electronic device operated in a standby mode and a normal mode; and
a local control unit configured to monitor load power consumed by the electronic device, and electrically connect or isolate the electronic device to or from a power line according to a result of the monitoring,
wherein the local control unit isolates the electronic device from the power line when the load power consumed by the electronic device is kept as the standby mode over a reference time.

14. The standby power control device of claim 13, further comprising a central control unit configured to control the local control unit so that the electronic device is changed to the standby mode by electrically connecting the electronic device to the power line by sensing use of the electronic device by a user or sensing an input which corresponds to a standby mode restoration, wherein the use by the user is sensed using a sensor.

15. The standby power control device of claim 14, further comprising a user input/output unit for sensing the use of the electronic device by the user and sensing the input which corresponds to the standby mode restoration, or receiving a configuration of the user.

16. The standby power control device of claim 14, wherein the local control unit comprises:
a device identifier storing unit configured to store device identifier information of the electronic device;
a power switch configured to switch the power line and power of the electronic device;
a load variation monitoring unit configured to periodically generate level information of the load power by monitoring the load power consumed by the electronic device, and control the power switch for electrically connect or isolate the electronic device to or from the power line according to a result of the monitoring; and
a local communication processing unit configured to combine the periodically generated level information of the load power and the device identifier information, and transmit the combined information to the central control unit.

17. The standby power control device of claim 14, wherein the central control unit comprises:
a profile storing unit configured to store profile information for identifying and configuring the electronic device;
a central communication processing unit configured to receive the level information of the load power, and transmit a command for isolating or connecting the electronic device from or to the power line; and
a device information management unit configured to provide the central communication processing unit with a command for electrically connecting the power line to the electronic device by referring to a device identifier included in the profile information in response to the sense of the use of the electronic device by the user through the sensor or the input which corresponds to the standby mode restoration.

18. A method for controlling standby power of a plurality of electronic devices, the method comprising:
detecting power consumed by each of the electronic devices;
determining whether there is one whose power consumption is kept as a standby mode over a reference time among the electronic devices; and
electrically isolating the electronic device which is kept as the standby mode over the reference time from a power line by referring to profile information,
wherein the profile information includes identifier information of an electronic device among the electronic devices whose connection to the power line is maintained even if it is kept as the standby mode over the reference time.

19. The method of claim 18, further comprising:
selecting conversion to the standby mode by sensing use of one of the electronic devices by a user through a sensor or sensing an input of the user; and
electrically connecting the power line to the electrically isolated electronic device by referring to the identifier information.

20. The method of claim 18, wherein at the step of detecting power consumed by each of the electronic devices, a falling edge of the consumed power is detected.
